(19) United States
(12) Patent Application Publication
(10) Pub. No.: US 2026/0067592 A1
(43) Pub. Date: Mar. 5, 2026

(54) AUTOMATED COLOR SELECTION FOR FOCUS PEAKING HIGHLIGHTING

(71) Applicant: GoPro, Inc., San Mateo, CA (US)

(72) Inventors: Stephane Valente, Paris (FR); Eric Chasseur, Le Pecq (FR)

(21) Appl. No.: 18/819,436

(22) Filed: Aug. 29, 2024

(51) Int. Cl. H04N 25/704; G06T 7/90

(52) U.S. Cl. CPC H04N 25/704; G06T 7/90; G06T 2207/10024

(57) ABSTRACT

Systems and methods are disclosed for automated color selection for focus peaking highlighting. For example, methods may include accessing a color image including a first component image, a second component image, and a third component image that each encode a dimension of a color space used to encode the color image; selecting pixels of the color image for focus peaking highlighting based on pixel values of the first component image; and determining a color for focus peaking highlighting based on the second component image and on the third component image.

### TECHNICAL FIELD

This disclosure relates to automated color selection for focus peaking highlighting.

### BACKGROUND

In order to assist users to manually find the correct focus position of a lens, some cameras propose focus peaking preview modes, in which a colored signal is overlaid over an image to indicate edges that have a high contrast on the preview display. This focus peaking highlighting may allow the user to get a visual indication of the objects in focus while doing focus manually, either by adjusting the focus distance on lenses that have variable focus or by moving the camera closer/farther to the scene to have objects of interest in focus. Focus peaking may be particularly useful for the manual focus of lenses that have a narrow depth of field, where the in-focus position varies rapidly with object depth. Even if a macro lens has a fixed focus position, focus peaking may be useful to a user to find the correct focus for an object by moving the camera.

### SUMMARY

Disclosed herein are implementations of automated color selection for focus peaking highlighting.

In a first aspect, the subject matter described in this specification can be embodied in systems that include: an image sensor and a processing apparatus that is configured to: access a color image, captured using the image sensor, including a first component image, a second component image, and a third component image that each encode a dimension of a color space used to encode the color image; select pixels of the color image for focus peaking highlighting based on pixel values of the first component image; and determine a color for focus peaking highlighting based on the second component image and on the third component image.

In a second aspect, the subject matter described in this specification can be embodied in methods that include accessing a color image including a first component image, a second component image, and a third component image that each encode a dimension of a color space used to encode the color image; selecting pixels of the color image for focus peaking highlighting based on pixel values of the first component image; and determining a color for focus peaking highlighting based on the second component image and on the third component image.

In a third aspect, the subject matter described in this specification can be embodied in a non-transitory computer-readable storage medium. The non-transitory computer-readable storage medium may include executable instructions that, when executed by a processor, cause performance of operations, comprising operations to: access a color image including a first component image, a second component image, and a third component image that each encode a dimension of a color space used to encode the color image; select pixels of the color image for focus peaking highlighting based on pixel values of the first component image; and determine a color for focus peaking highlighting based on the second component image and on the third component image.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A-1B are isometric views of an example of an image capture apparatus.

FIG. 2A-2B are isometric views of another example of an image capture apparatus.

FIG. 3 is a top view of another example of an image capture apparatus.

FIG. 4A-4B are isometric views of another example of an image capture apparatus.

FIG. 5 is a block diagram of electronic components of an image capture apparatus.

FIG. 6 is a flow diagram of an example of an image processing pipeline.

FIG. 7 is a flowchart of an example of a technique for applying focus peaking highlighting with automated color selection to dynamically suit a scene.

FIG. 8 is a flowchart of an example of a technique for applying focus peaking highlighting to frames of video with a delay in the adjustment of color for focus peaking highlighting.

FIG. 9 is a flowchart of an example of a technique for selecting pixels of a color image for focus peaking highlighting.

FIG. 10 is a flowchart of an example of a technique for determining a color for focus peaking highlighting.

FIGS. 11A-11B are illustrations of examples of a normalized color representation for a scene and a corresponding color for focus peaking highlighting in a plane of color components.

### DETAILED DESCRIPTION

A camera may be configured to let a user manually choose the focus peaking color from among a set of predefined colors (e.g., red, yellow or blue). However, the focus peaking visibility also depends on the scene colors. Choosing yellow in a mostly yellow scene would make the focus peaking highlighting hardly visible on a preview image. Green for plants and vegetation may be a poor choice as well. During longer recording sessions, the dominant color in the scene can change. The color chosen before pressing the “record” button for video capture may no longer be the best choice.

Some implementations described herein may address these problems by analyzing the colors in the scene, and adaptively selecting a color for focus peaking highlighting that will provide the enhanced visibility given the current circumstances of the scene. For example, a color image may be analyzed to select a color for focus peaking highlighting for itself or a related image of the scene (e.g., a later frame of video in a sequence of frames of video). For example, the color image may be encoded in a YUV 4:2:0 semi-planar 8-bit format, which has a higher resolution for the luminance (Y) channel than for the chrominance channels (U and V). Semi-planar means that we get a Y plane, where each sample is the luminance between 0 and 255 of a picture RGB pixel. U and V samples are interleaved in a second plane, and represent two “chrominance” components, sometimes called “blue projection” (U) and “red projection” (V) respectively. 4:2:0 chroma format sampling means that for each 2×2 group of Y luminance samples, we get one U sample and one V sample. Color matrices enable transformations to go from RGB to YUV, and vice-versa. When encoded on 8 bits as unsigned integers, the value 128 for U and V may represent “neutral chrominance”, i.e. no chrominance, when transformed back to RGB. Such samples may happen to be grey-level only. Another name of this encoding is YCbCr, but for historical reasons, it is often called YUV.

The analysis of a color image used to determine what color will be used for focus peaking highlighting may include computing a focus peaking signal based on application of a 2D edge filter (e.g., a Sobel filter) to a luminance channel component image of the color image and then selecting pixels for highlighting based on having corresponding focus peaking signal above a threshold. Where there is a difference in resolution between the different channels of the color space encoding of the color image, statistics for a neighborhood of luminance pixels centered around a pair of chrominance pixels may be used to determine the focus peaking signal for that pair of chrominance pixels. For example, the maximum magnitude values of an edge filter response over a 2×2 Y neighborhood may be used to determine the focus peaking signal for one U and one V sample (remember that the input pixel format is YUV 4:2:0, you get 4 luminance samples for one U sample and one V sample). Optionally, a larger neighborhood, for instance 4×4, can be used, to enlarge the focus peaking signal. The threshold may be used to avoid adding noise as focus peaking highlighting. That is, focus peaking highlighting is only added when the focus peaking signal is large enough. U and/or V samples may be modified according to the focus peaking color (e.g., offsetting or replacing the color of the selected pixel based on the color selected for focus peaking highlighting in the color image.

For efficiency reasons, it may be advantageous to perform only one pass over a picture to avoid multiple memory accesses for a given set of pixels. In some implementations, U and V statistics may be collected while computing and applying the focus peaking signal, to read and write the U and V samples only once. As a result, after processing a picture, this algorithm can select a color that will be used for the next picture (e.g., the next frame of video in a sequence of frames of video). In this example, the automatic color selection has a one-frame delay.

Computing chrominance channel (e.g., U and V) statistics on the whole picture may not be representative of the edges of the scene, or the color of objects where most of the focus peaking signal will be applied. In some implementations, chrominance channel statistics are computed only for the samples where the focus peaking signal is above a threshold, i.e., the pixels selected for focus peaking highlighting.

Picking a single focus peaking color for a picture may not provide maximum visibility, as the scene may contain objects of different colors. In some implementations, the adaptive color selection can be done per pixel, instead of per picture.

When an opposite color to the dominant color of the scene is selected, the focus peaking signal may be added in the opposite direction of the current U/V vector, and small focus peaking signal values tend to void the current U/V values towards gray levels. In some implementations, instead of adding the focus peaking signal to the current U and/or V samples, a “clean slate” mode may be used that sets U and V pixel values to a neutral value of 128 on an 8-bit scale before adding the focus peaking highlighting to the pixel based on the selected color for focus peaking highlighting.

In some implementations, instead of adding the focus peaking signal in the opposite U/V direction, the focus peaking signal may be added in an orthogonal direction.

In some implementations, instead of adding the focus peaking signal values along predefined discrete directions, we could consider the actual U/V directions and subtract the focus peaking signal values along the unit vector of (U, V).

In some implementations, instead of working in the 4:2:0 YUV color space, we could work in alternative color spaces, such as RGB, HSV (hue, saturation, value), or a more perceptual L*a*b* color space where color perception differences are more consistent with the Euclidian distance in this space.

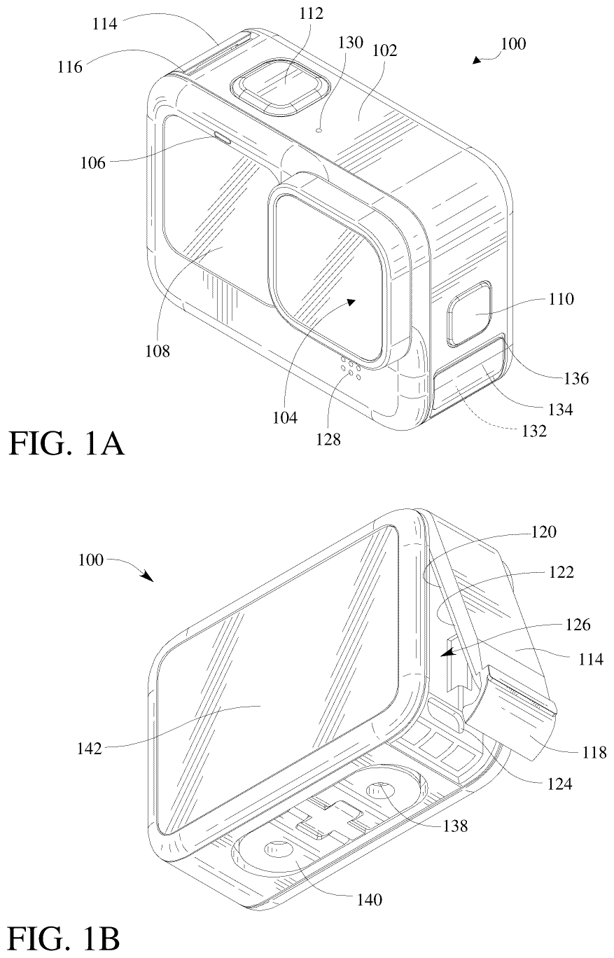

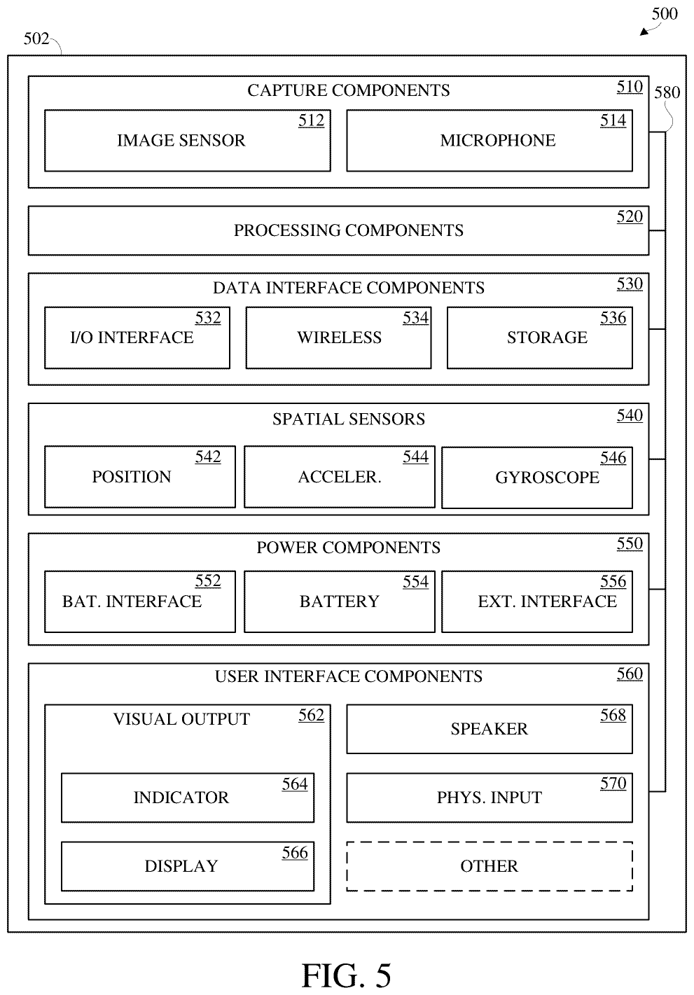

FIG. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIG. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIG. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIG. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

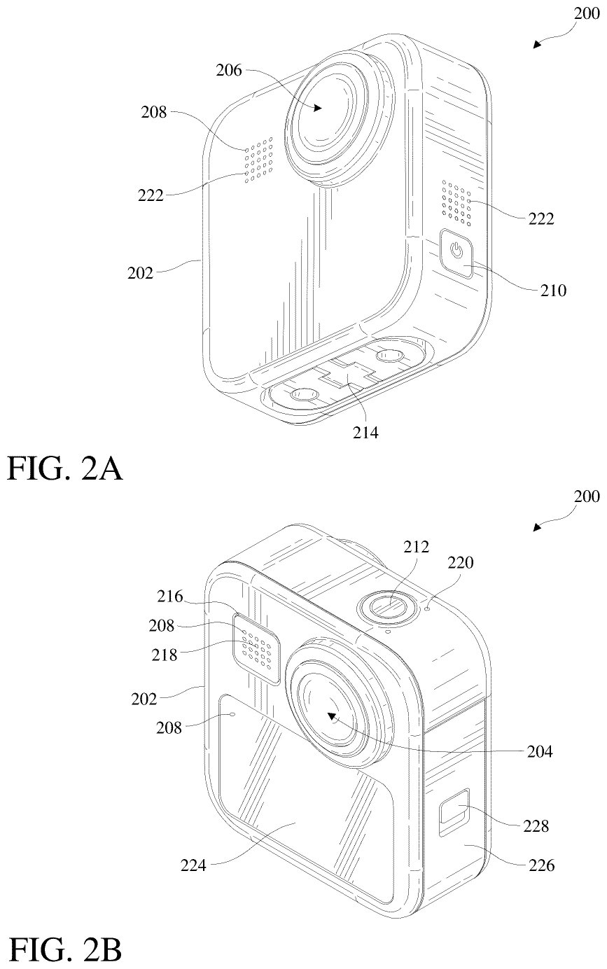

FIG. 2A-2B illustrate another example of an image capture apparatus 200. The image capture apparatus 200 is similar to the image capture apparatus 100 shown in FIG. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIG. 2A-2B is an example, other arrangements of elements may be used.

The body 202 of the image capture apparatus 200 may be similar to the body 102 shown in FIG. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIG. 2A-2B, the image capture apparatus 200 may include other indictors structured on respective surfaces of the body 202.

As shown in FIG. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIG. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIG. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIG. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIG. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIG. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

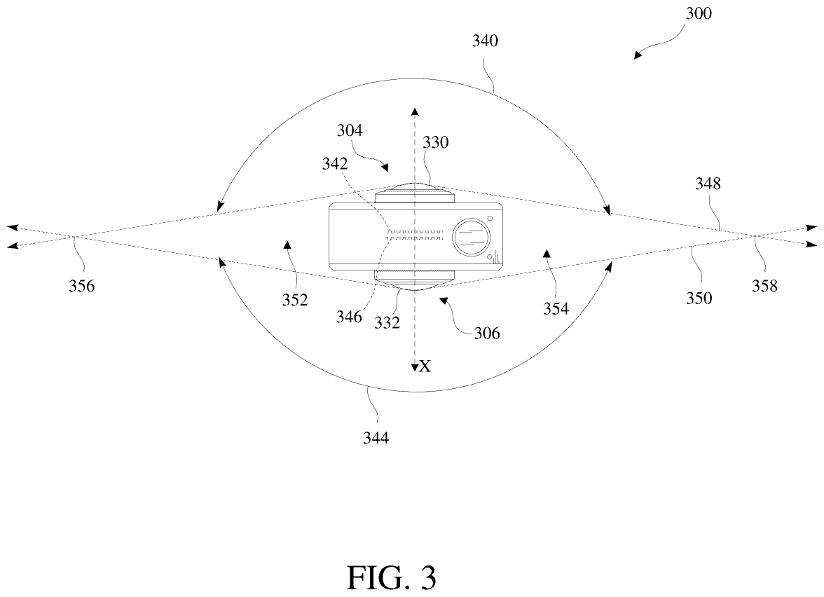

FIG. 3 is a top view of an image capture apparatus 300. The image capture apparatus 300 is similar to the image capture apparatus 200 of FIG. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

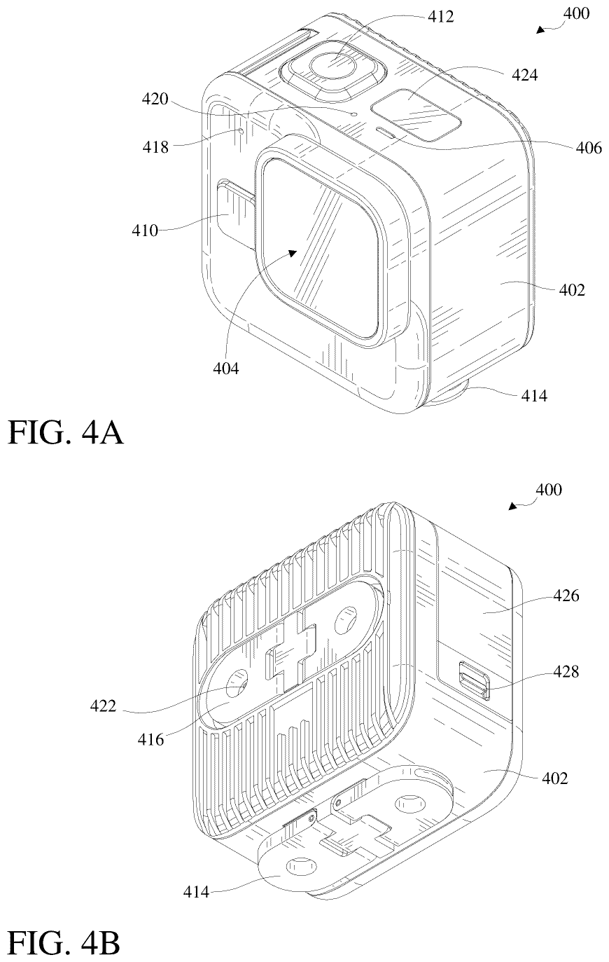

FIG. 4A-4B illustrate another example of an image capture apparatus 400. The image capture apparatus 400 is similar to the image capture apparatus 100 shown in FIG. 1A-1B and to the image capture apparatus 200 shown in FIG. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIG. 4A-4B is an example, other arrangements of elements may be used.

The body 402 of the image capture apparatus 400 may be similar to the body 102 shown in FIG. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIG. 4A, the image capture apparatus 400 may include other indictors structured on respective surfaces of the body 402.

As shown in FIG. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIG. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIG. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIG. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIG. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIG. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIG. 1A-1B, the image capture apparatus 200 shown in FIG. 2A-2B, the image capture apparatus 300 shown in FIG. 3, or the image capture apparatus 400 shown in FIG. 4A-4B, may be implemented as shown in FIG. 5.

The image capture apparatus 500 includes a body 502. The body 502 may be similar to the body 102 shown in FIG. 1A-1B, the body 202 shown in FIG. 2A-2B, or the body 402 shown in FIG. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIG. 1A-1B, the audio components 218, 220, 222 shown in FIG. 2A-2B, or the audio components 418, 420, 422 shown in FIG. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIG. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIG. 2A-2B, or the audio components 418, 420, 422 shown in FIG. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

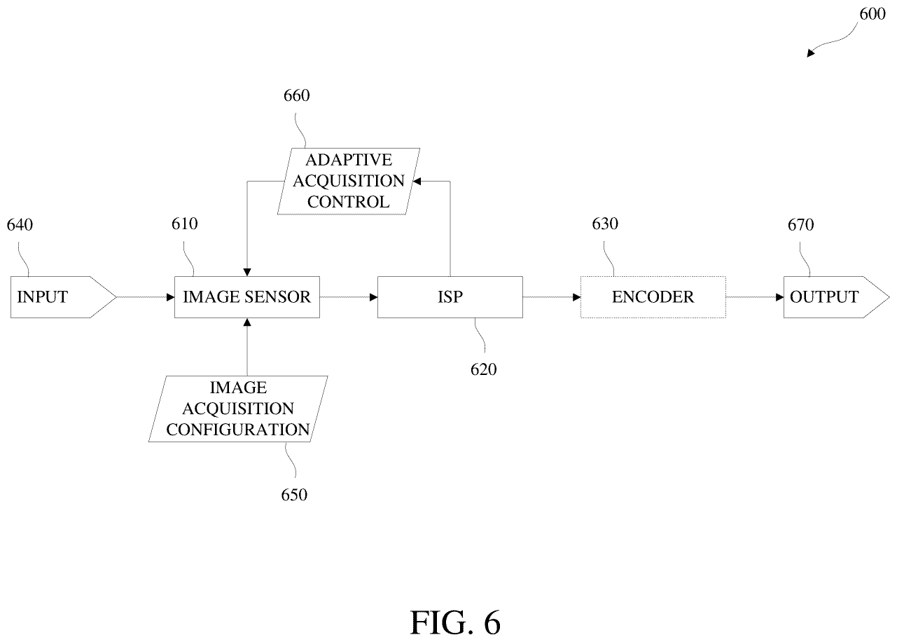

FIG. 6 is a block diagram of an example of an image processing pipeline 600. The image processing pipeline 600, or a portion thereof, is implemented in an image capture apparatus, such as the image capture apparatus 100 shown in FIG. 1A-1B, the image capture apparatus 200 shown in FIG. 2A-2B, the image capture apparatus 300 shown in FIG. 3, the image capture apparatus 400 shown in FIG. 4A-4B, or another image capture apparatus. In some implementations, the image processing pipeline 600 may be implemented in a digital signal processor (DSP), an application-specific integrated circuit (ASIC), or a combination of a digital signal processor and an application-specific integrated circuit. One or more components of the pipeline 600 may be implemented in hardware, software, or a combination of hardware and software.

As shown in FIG. 6, the image processing pipeline 600 includes an image sensor 610, an image signal processor (ISP) 620, and an encoder 630. The encoder 630 is shown with a broken line border to indicate that the encoder may be omitted, or absent, from the image processing pipeline 600. In some implementations, the encoder 630 may be included in another device. In implementations that include the encoder 630, the image processing pipeline 600 may be an image processing and coding pipeline. The image processing pipeline 600 may include components other than the components shown in FIG. 6.

The image sensor 610 receives input 640, such as photons incident on the image sensor 610. The image sensor 610 captures image data (source image data). Capturing source image data includes measuring or sensing the input 640, which may include counting, or otherwise measuring, photons incident on the image sensor 610, such as for a defined temporal duration or period (exposure). Capturing source image data includes converting the analog input 640 to a digital source image signal in a defined format, which may be referred to herein as “a raw image signal.” For example, the raw image signal may be in a format such as RGB format, which may represent individual pixels using a combination of values or components, such as a red component (R), a green component (G), and a blue component (B). In another example, the raw image signal may be in a Bayer format, wherein a respective pixel may be one of a combination of adjacent pixels, such as a combination of four adjacent pixels, of a Bayer pattern.

Although one image sensor 610 is shown in FIG. 6, the image processing pipeline 600 may include two or more image sensors. In some implementations, an image, or frame, such as an image, or frame, included in the source image signal, may be one of a sequence or series of images or frames of a video, such as a sequence, or series, of frames captured at a rate, or frame rate, which may be a number or cardinality of frames captured per defined temporal period, such as twenty-four, thirty, sixty, or one-hundred twenty frames per second.

The image sensor 610 obtains image acquisition configuration data 650. The image acquisition configuration data 650 may include image cropping parameters, binning/skipping parameters, pixel rate parameters, bitrate parameters, resolution parameters, framerate parameters, or other image acquisition configuration data or combinations of image acquisition configuration data. Obtaining the image acquisition configuration data 650 may include receiving the image acquisition configuration data 650 from a source other than a component of the image processing pipeline 600. For example, the image acquisition configuration data 650, or a portion thereof, may be received from another component, such as a user interface component, of the image capture apparatus implementing the image processing pipeline 600, such as one or more of the user interface components 560 shown in FIG. 5. The image sensor 610 obtains, outputs, or both, the source image data in accordance with the image acquisition configuration data 650. For example, the image sensor 610 may obtain the image acquisition configuration data 650 prior to capturing the source image.

The image sensor 610 receives, or otherwise obtains or accesses, adaptive acquisition control data 660, such as auto exposure (AE) data, auto white balance (AWB) data, global tone mapping (GTM) data, Auto Color Lens Shading (ACLS) data, color correction data, or other adaptive acquisition control data or combination of adaptive acquisition control data. For example, the image sensor 610 receives the adaptive acquisition control data 660 from the image signal processor 620. The image sensor 610 obtains, outputs, or both, the source image data in accordance with the adaptive acquisition control data 660.

The image sensor 610 controls, such as configures, sets, or modifies, one or more image acquisition parameters or settings, or otherwise controls the operation of the image signal processor 620, in accordance with the image acquisition configuration data 650 and the adaptive acquisition control data 660. For example, the image sensor 610 may capture a first source image using, or in accordance with, the image acquisition configuration data 650, and in the absence of adaptive acquisition control data 660 or using defined values for the adaptive acquisition control data 660, output the first source image to the image signal processor 620, obtain adaptive acquisition control data 660 generated using the first source image data from the image signal processor 620, and capture a second source image using, or in accordance with, the image acquisition configuration data 650 and the adaptive acquisition control data 660 generated using the first source image. In an example, the adaptive acquisition control data 660 may include an exposure duration value and the image sensor 610 may capture an image in accordance with the exposure duration value.

The image sensor 610 outputs source image data, which may include the source image signal, image acquisition data, or a combination thereof, to the image signal processor 620.

The image signal processor 620 receives, or otherwise accesses or obtains, the source image data from the image sensor 610. The image signal processor 620 processes the source image data to obtain input image data. In some implementations, the image signal processor 620 converts the raw image signal (RGB data) to another format, such as a format expressing individual pixels using a combination of values or components, such as a luminance, or luma, value (Y), a blue chrominance, or chroma, value (U or Cb), and a red chroma value (V or Cr), such as the YUV or YCbCr formats.

Processing the source image data includes generating the adaptive acquisition control data 660. The adaptive acquisition control data 660 includes data for controlling the acquisition of a one or more images by the image sensor 610.

The image signal processor 620 includes components not expressly shown in FIG. 6 for obtaining and processing the source image data. For example, the image signal processor 620 may include one or more sensor input (SEN) components (not shown), one or more sensor readout (SRO) components (not shown), one or more image data compression components, one or more image data decompression components, one or more internal memory, or data storage, components, one or more Bayer-to-Bayer (B2B) components, one or more local motion estimation (LME) components, one or more local motion compensation (LMC) components, one or more global motion compensation (GMC) components, one or more Bayer-to-RGB (B2R) components, one or more image processing units (IPU), one or more high dynamic range (HDR) components, one or more three-dimensional noise reduction (3DNR) components, one or more sharpening components, one or more raw-to-YUV (R2Y) components, one or more Chroma Noise Reduction (CNR) components, one or more local tone mapping (LTM) components, one or more YUV-to-YUV (Y2Y) components, one or more warp and blend components, one or more stitching cost components, one or more scaler components, or a configuration controller. The image signal processor 620, or respective components thereof, may be implemented in hardware, software, or a combination of hardware and software. Although one image signal processor 620 is shown in FIG. 6, the image processing pipeline 600 may include multiple image signal processors. In implementations that include multiple image signal processors, the functionality of the image signal processor 620 may be divided or distributed among the image signal processors.

In some implementations, the image signal processor 620 may implement or include multiple parallel, or partially parallel paths for image processing. For example, for high dynamic range image processing based on two source images, the image signal processor 620 may implement a first image processing path for a first source image and a second image processing path for a second source image, wherein the image processing paths may include components that are shared among the paths, such as memory components, and may include components that are separately included in each path, such as a first sensor readout component in the first image processing path and a second sensor readout component in the second image processing path, such that image processing by the respective paths may be performed in parallel, or partially in parallel.

The image signal processor 620, or one or more components thereof, such as the sensor input components, may perform black-point removal for the image data. In some implementations, the image sensor 610 may compress the source image data, or a portion thereof, and the image signal processor 620, or one or more components thereof, such as one or more of the sensor input components or one or more of the image data decompression components, may decompress the compressed source image data to obtain the source image data.

The image signal processor 620, or one or more components thereof, such as the sensor readout components, may perform dead pixel correction for the image data. The sensor readout component may perform scaling for the image data. The sensor readout component may obtain, such as generate or determine, adaptive acquisition control data, such as auto exposure data, auto white balance data, global tone mapping data, Auto Color Lens Shading data, or other adaptive acquisition control data, based on the source image data.

The image signal processor 620, or one or more components thereof, such as the image data compression components, may obtain the image data, or a portion thereof, such as from another component of the image signal processor 620, compress the image data, and output the compressed image data, such as to another component of the image signal processor 620, such as to a memory component of the image signal processor 620.

The image signal processor 620, or one or more components thereof, such as the image data decompression, or uncompression, components (UCX), may read, receive, or otherwise access, compressed image data and may decompress, or uncompress, the compressed image data to obtain image data. In some implementations, other components of the image signal processor 620 may request, such as send a request message or signal, the image data from an uncompression component, and, in response to the request, the uncompression component may obtain corresponding compressed image data, uncompress the compressed image data to obtain the requested image data, and output, such as send or otherwise make available, the requested image data to the component that requested the image data. The image signal processor 620 may include multiple uncompression components, which may be respectively optimized for uncompression with respect to one or more defined image data formats.

The image signal processor 620, or one or more components thereof, such as the internal memory, or data storage, components. The memory components store image data, such as compressed image data internally within the image signal processor 620 and are accessible to the image signal processor 620, or to components of the image signal processor 620. In some implementations, a memory component may be accessible, such as write accessible, to a defined component of the image signal processor 620, such as an image data compression component, and the memory component may be accessible, such as read accessible, to another defined component of the image signal processor 620, such as an uncompression component of the image signal processor 620.

The image signal processor 620, or one or more components thereof, such as the Bayer-to-Bayer components, which may process image data, such as to transform or convert the image data from a first Bayer format, such as a signed 15-bit Bayer format data, to second Bayer format, such as an unsigned 14-bit Bayer format. The Bayer-to-Bayer components may obtain, such as generate or determine, high dynamic range Tone Control data based on the current image data.

Although not expressly shown in FIG. 6, in some implementations, a respective Bayer-to-Bayer component may include one or more sub-components. For example, the Bayer-to-Bayer component may include one or more gain components. In another example, the Bayer-to-Bayer component may include one or more offset map components, which may respectively apply respective offset maps to the image data. The respective offset maps may have a configurable size, which may have a maximum size, such as 129×129. The respective offset maps may have a non-uniform grid. Applying the offset map may include saturation management, which may preserve saturated areas on respective images based on R, G, and B values. The values of the offset map may be modified per-frame and double buffering may be used for the map values. A respective offset map component may, such as prior to Bayer noise removal (denoising), compensate for non-uniform black point removal, such as due to non-uniform thermal heating of the sensor or image capture device. A respective offset map component may, such as subsequent to Bayer noise removal, compensate for flare, such as flare on hemispherical lenses, and/or may perform local contrast enhancement, such a dehazing or local tone mapping.

In another example, the Bayer-to-Bayer component may include a Bayer Noise Reduction (Bayer NR) component, which may convert image data, such as from a first format, such as a signed 15-bit Bayer format, to a second format, such as an unsigned 14-bit Bayer format. In another example, the Bayer-to-Bayer component may include one or more lens shading (FSHD) component, which may, respectively, perform lens shading correction, such as luminance lens shading correction, color lens shading correction, or both. In some implementations, a respective lens shading component may perform exposure compensation between two or more sensors of a multi-sensor image capture apparatus, such as between two hemispherical lenses. In some implementations, a respective lens shading component may apply map-based gains, radial model gain, or a combination, such as a multiplicative combination, thereof. In some implementations, a respective lens shading component may perform saturation management, which may preserve saturated areas on respective images. Map and lookup table values for a respective lens shading component may be configured or modified on a per-frame basis and double buffering may be used.

In another example, the Bayer-to-Bayer component may include a PZSFT component. In another example, the Bayer-to-Bayer component may include a half-RGB (½ RGB) component. In another example, the Bayer-to-Bayer component may include a color correction (CC) component, which may obtain subsampled data for local tone mapping, which may be used, for example, for applying an unsharp mask. In another example, the Bayer-to-Bayer component may include a Tone Control (TC) component, which may obtain subsampled data for local tone mapping, which may be used, for example, for applying an unsharp mask. In another example, the Bayer-to-Bayer component may include a Gamma (GM) component, which may apply a lookup-table independently per channel for color rendering (gamma curve application). Using a lookup-table, which may be an array, may reduce resource utilization, such as processor utilization, using an array indexing operation rather than more complex computation. The gamma component may obtain subsampled data for local tone mapping, which may be used, for example, for applying an unsharp mask.

In another example, the Bayer-to-Bayer component may include an RGB binning (RGB BIN) component, which may include a configurable binning factor, such as a binning factor configurable in the range from four to sixteen, such as four, eight, or sixteen. One or more sub-components of the Bayer-to-Bayer component, such as the RGB Binning component and the half-RGB component, may operate in parallel. The RGB binning component may output image data, such as to an external memory, which may include compressing the image data. The output of the RGB binning component may be a binned image, which may include low-resolution image data or low-resolution image map data. The output of the RGB binning component may be used to extract statistics for combing images, such as combining hemispherical images. The output of the RGB binning component may be used to estimate flare on one or more lenses, such as hemispherical lenses. The RGB binning component may obtain G channel values for the binned image by averaging Gr channel values and Gb channel values. The RGB binning component may obtain one or more portions of or values for the binned image by averaging pixel values in spatial areas identified based on the binning factor. In another example, the Bayer-to-Bayer component may include, such as for spherical image processing, an RGB-to-YUV component, which may obtain tone mapping statistics, such as histogram data and thumbnail data, using a weight map, which may weight respective regions of interest prior to statistics aggregation.

The image signal processor 620, or one or more components thereof, such as the local motion estimation components, which may generate local motion estimation data for use in image signal processing and encoding, such as in correcting distortion, stitching, and/or motion compensation. For example, the local motion estimation components may partition an image into blocks, arbitrarily shaped patches, individual pixels, or a combination thereof. The local motion estimation components may compare pixel values between frames, such as successive images, to determine displacement, or movement, between frames, which may be expressed as motion vectors (local motion vectors).

The image signal processor 620, or one or more components thereof, such as the local motion compensation components, which may obtain local motion data, such as local motion vectors, and may spatially apply the local motion data to an image to obtain a local motion compensated image or frame and may output the local motion compensated image or frame to one or more other components of the image signal processor 620.

The image signal processor 620, or one or more components thereof, such as the global motion compensation components, may receive, or otherwise access, global motion data, such as global motion data from a gyroscopic unit of the image capture apparatus, such as the gyroscope 546 shown in FIG. 5, corresponding to the current frame. The global motion compensation component may apply the global motion data to a current image to obtain a global motion compensated image, which the global motion compensation component may output, or otherwise make available, to one or more other components of the image signal processor 620.

The image signal processor 620, or one or more components thereof, such as the Bayer-to-RGB components, which convert the image data from Bayer format to an RGB format. The Bayer-to-RGB components may implement white balancing and demosaicing. The Bayer-to-RGB components respectively output, or otherwise make available, RGB format image data to one or more other components of the image signal processor 620.

The image signal processor 620, or one or more components thereof, such as the image processing units, which perform warping, image registration, electronic image stabilization, motion detection, object detection, or the like. The image processing units respectively output, or otherwise make available, processed, or partially processed, image data to one or more other components of the image signal processor 620.

The image signal processor 620, or one or more components thereof, such as the high dynamic range components, may, respectively, generate high dynamic range images based on the current input image, the corresponding local motion compensated frame, the corresponding global motion compensated frame, or a combination thereof. The high dynamic range components respectively output, or otherwise make available, high dynamic range images to one or more other components of the image signal processor 620.

The high dynamic range components of the image signal processor 620 may, respectively, include one or more high dynamic range core components, one or more tone control (TC) components, or one or more high dynamic range core components and one or more tone control components. For example, the image signal processor 620 may include a high dynamic range component that includes a high dynamic range core component and a tone control component. The high dynamic range core component may obtain, or generate, combined image data, such as a high dynamic range image, by merging, fusing, or combining the image data, such as unsigned 14-bit RGB format image data, for multiple, such as two, images (HDR fusion) to obtain, and output, the high dynamic range image, such as in an unsigned 23-bit RGB format (full dynamic data). The high dynamic range core component may output the combined image data to the Tone Control component, or to other components of the image signal processor 620. The Tone Control component may compress the combined image data, such as from the unsigned 23-bit RGB format data to an unsigned 17-bit RGB format (enhanced dynamic data).

The image signal processor 620, or one or more components thereof, such as the three-dimensional noise reduction components reduce image noise for a frame based on one or more previously processed frames and output, or otherwise make available, noise reduced images to one or more other components of the image signal processor 620. In some implementations, the three-dimensional noise reduction component may be omitted or may be replaced by one or more lower-dimensional noise reduction components, such as by a spatial noise reduction component. The three-dimensional noise reduction components of the image signal processor 620 may, respectively, include one or more temporal noise reduction (TNR) components, one or more raw-to-raw (R2R) components, or one or more temporal noise reduction components and one or more raw-to-raw components. For example, the image signal processor 620 may include a three-dimensional noise reduction component that includes a temporal noise reduction component and a raw-to-raw component.

The image signal processor 620, or one or more components thereof, such as the sharpening components, obtains sharpened image data based on the image data, such as based on noise reduced image data, which may recover image detail, such as detail reduced by temporal denoising or warping. The sharpening components respectively output, or otherwise make available, sharpened image data to one or more other components of the image signal processor 620.

The image signal processor 620, or one or more components thereof, such as the raw-to-YUV components, may transform, or convert, image data, such as from the raw image format to another image format, such as the YUV format, which includes a combination of a luminance (Y) component and two chrominance (UV) components. The raw-to-YUV components may, respectively, demosaic, color process, or both, images.

Although not expressly shown in FIG. 6, in some implementations, a respective raw-to-YUV component may include one or more sub-components. For example, the raw-to-YUV component may include a white balance (WB) component, which performs white balance correction on the image data. In another example, a respective raw-to-YUV component may include one or more color correction components (CC0, CC1), which may implement linear color rendering, which may include applying a 3×3 color matrix. For example, the raw-to-YUV component may include a first color correction component (CC0) and a second color correction component (CC1). In another example, a respective raw-to-YUV component may include a three-dimensional lookup table component, such as subsequent to a first color correction component. Although not expressly shown in FIG. 6, in some implementations, a respective raw-to-YUV component may include a Multi-Axis Color Correction (MCC) component, such as subsequent to a three-dimensional lookup table component, which may implement non-linear color rendering, such as in Hue, Saturation, Value (HSV) space.

In another example, a respective raw-to-YUV component may include a black point RGB removal (BPRGB) component, which may process image data, such as low intensity values, such as values within a defined intensity threshold, such as less than or equal to, 2⁸, to obtain histogram data wherein values exceeding a defined intensity threshold may be omitted, or excluded, from the histogram data processing. In another example, a respective raw-to-YUV component may include a Multiple Tone Control (Multi-TC) component, which may convert image data, such as unsigned 17-bit RGB image data, to another format, such as unsigned 14-bit RGB image data. The Multiple Tone Control component may apply dynamic tone mapping to the Y channel (luminance) data, which may be based on, for example, image capture conditions, such as light conditions or scene conditions. The tone mapping may include local tone mapping, global tone mapping, or a combination thereof.

In another example, a respective raw-to-YUV component may include a Gamma (GM) component, which may convert image data, such as unsigned 14-bit RGB image data, to another format, such as unsigned 10-bit RGB image data. The Gamma component may apply a lookup-table independently per channel for color rendering (gamma curve application). Using a lookup-table, which may be an array, may reduce resource utilization, such as processor utilization, using an array indexing operation rather than more complex computation. In another example, a respective raw-to-YUV component may include a three-dimensional lookup table (3DLUT) component, which may include, or may be, a three-dimensional lookup table, which may map RGB input values to RGB output values through a non-linear function for non-linear color rendering. In another example, a respective raw-to-YUV component may include a Multi-Axis Color Correction (MCC) component, which may implement non-linear color rendering. For example, the multi-axis color correction component may perform color non-linear rendering, such as in Hue, Saturation, Value (HSV) space.

The image signal processor 620, or one or more components thereof, such as the Chroma Noise Reduction (CNR) components, may perform chroma denoising, luma denoising, or both.

The image signal processor 620, or one or more components thereof, such as the local tone mapping components, may perform multi-scale local tone mapping using a single pass approach or a multi-pass approach on a frame at different scales. The local tone mapping components may, respectively, enhance detail and may omit introducing artifacts. For example, the Local Tone Mapping components may, respectively, apply tone mapping, which may be similar to applying an unsharp-mask. Processing an image by the local tone mapping components may include obtaining, processing, such as in response to gamma correction, tone control, or both, and using a low-resolution map for local tone mapping.

The image signal processor 620, or one or more components thereof, such as the YUV-to-YUV (Y2Y) components, may perform local tone mapping of YUV images. In some implementations, the YUV-to-YUV components may include multi-scale local tone mapping using a single pass approach or a multi-pass approach on a frame at different scales.

The image signal processor 620, or one or more components thereof, such as the warp and blend components, may warp images, blend images, or both. In some implementations, the warp and blend components may warp a corona around the equator of a respective frame to a rectangle. For example, the warp and blend components may warp a corona around the equator of a respective frame to a rectangle based on the corresponding low-resolution frame. The warp and blend components, may, respectively, apply one or more transformations to the frames, such as to correct for distortions at image edges, which may be subject to a close to identity constraint.

The image signal processor 620, or one or more components thereof, such as the stitching cost components, may generate a stitching cost map, which may be represented as a rectangle having disparity (x) and longitude (y) based on a warping. Respective values of the stitching cost map may be a cost function of a disparity (x) value for a corresponding longitude. Stitching cost maps may be generated for various scales, longitudes, and disparities.

The image signal processor 620, or one or more components thereof, such as the scaler components, may scale images, such as in patches, or blocks, of pixels, such as 16×16 blocks, 8×8 blocks, or patches or blocks of any other size or combination of sizes.

The image signal processor 620, or one or more components thereof, such as the configuration controller, may control the operation of the image signal processor 620, or the components thereof.

The image signal processor 620 outputs processed image data, such as by storing the processed image data in a memory of the image capture apparatus, such as external to the image signal processor 620, or by sending, or otherwise making available, the processed image data to another component of the image processing pipeline 600, such as the encoder 630, or to another component of the image capture apparatus.

The encoder 630 encodes or compresses the output of the image signal processor 620. In some implementations, the encoder 630 implements one or more encoding standards, which may include motion estimation. The encoder 630 outputs the encoded processed image to an output 670. In an embodiment that does not include the encoder 630, the image signal processor 620 outputs the processed image to the output 670. The output 670 may include, for example, a display, such as a display of the image capture apparatus, such as one or more of the displays 108, 142 shown in FIG. 1A-1B, the display 224 shown in FIG. 2B, the display 424 shown in FIG. 4A, or the display 566 shown in FIG. 5, to a storage device, or both. The output 670 is a signal, such as to an external device.

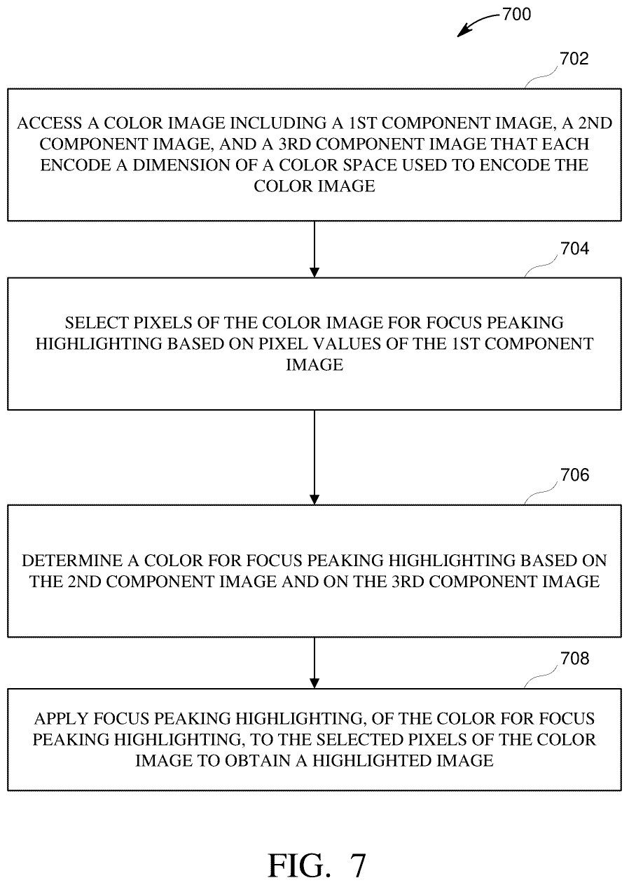

FIG. 7 is a flowchart of an example of a technique 700 focus peaking highlighting with automated color selection to dynamically suit a scene. The technique 700 includes accessing 702 a color image including a first component image, a second component image, and a third component image that each encode a dimension of a color space used to encode the color image; selecting 704 pixels of the color image for focus peaking highlighting based on pixel values of the first component image; determining 706 a color for focus peaking highlighting based on the second component image and on the third component image; and applying 708 focus peaking highlighting, of the color for focus peaking highlighting, to the selected pixels of the color image to obtain a highlighted image. For example, the technique 700 may be implemented using the image capture apparatus 100 of FIGS. 1A-B. For example, the technique 700 may be implemented using the image capture apparatus 200 of FIGS. 2A-B. For example, the technique 700 may be implemented using the image capture apparatus 300 of FIG. 3. For example, the technique 700 may be implemented using the image capture apparatus 400 of FIG. 4. For example, the technique 700 may be implemented using an image sensor (e.g., the image sensor 512) and a processing apparatus (e.g., including the processing components 520 of the image capture apparatus 500 of FIG. 5). Software for implementing the technique 700 may be stored on a non-transitory computer-readable storage medium storing executable instructions that, when executed by a processor, cause performance of operations used to implement the technique 700.

The technique 700 includes accessing 702 a color image including a first component image, a second component image, and a third component image that each encode a dimension of a color space used to encode the color image. The color image may be encoded in many different formats, using various color space representations (e.g., YUV, RGB, HSV (hue, saturation, value), or the L*a*b* color space). In some implementations, the first component image encodes luminance pixel values, the second component image encodes a first chrominance channel of the color image, and the third component image encodes a second chrominance channel of the color image. The color image may have been converted between different color spaces between when it is captured using an image sensor (e.g., the image sensor 512) and when it is accessed 702. For example, the color image may be captured in an RGB format, converted to a YCbCr format and then accessed 702 as a YCbCr color image. The different component images of the color image may be encoded with different resolutions.

For example, the color image may be encoded as a YUV 4:2:0 semi-planar 8-bit picture, where for every four luminance pixels corresponds to one pixel from each of the two chrominance channels (U, V). For example, the color image may be accessed 702 from an image sensor (e.g., the image sensor 512) via a bus (e.g., the bus 580). In some implementations, the color image may be accessed 702 via a communications link. For example, the color image may be accessed 702 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the color image may be accessed 702 via the data interface components 530. For example, the color image may be accessed 702 via an ISP (e.g., the ISP 620) that performs some initial processing on the accessed 702 color image. For example, the color image may be stored in a format using the Bayer color mosaic pattern. In some implementations, the color image may be a frame of video. In some implementations, the color image may be a still image.

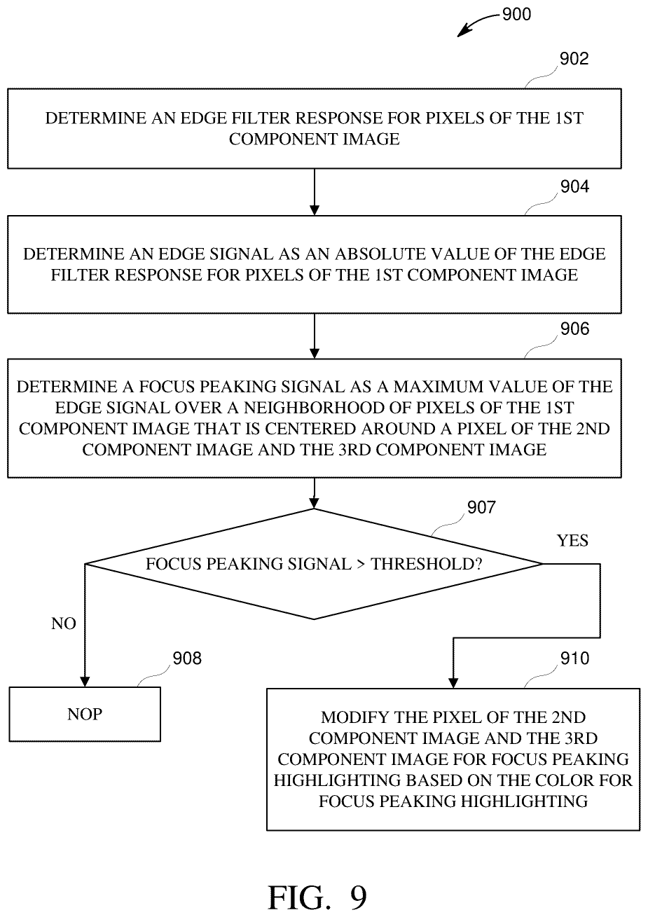

The technique 700 includes selecting 704 pixels of the color image for focus peaking highlighting based on pixel values of the first component image. In some implementations, pixels may be selected 704 for focus peaking highlighting based on application of a 2-D edge filter (e.g., a Sobel filter) to the first component image (e.g., a luminance channel component image). For example, the technique 900 of FIG. 9 may be used to select 704 pixels of the color image for focus peaking highlighting based on pixel values of the first component image.

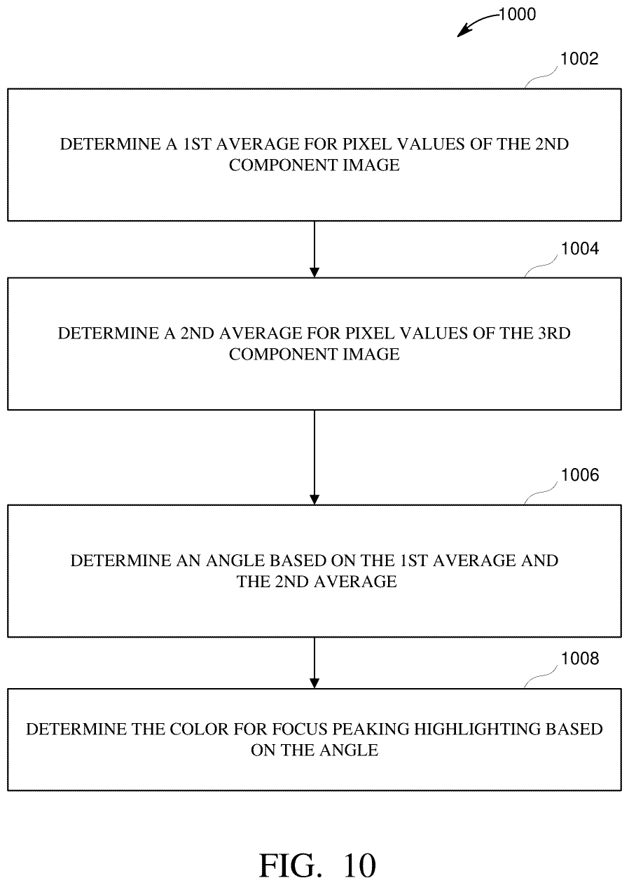

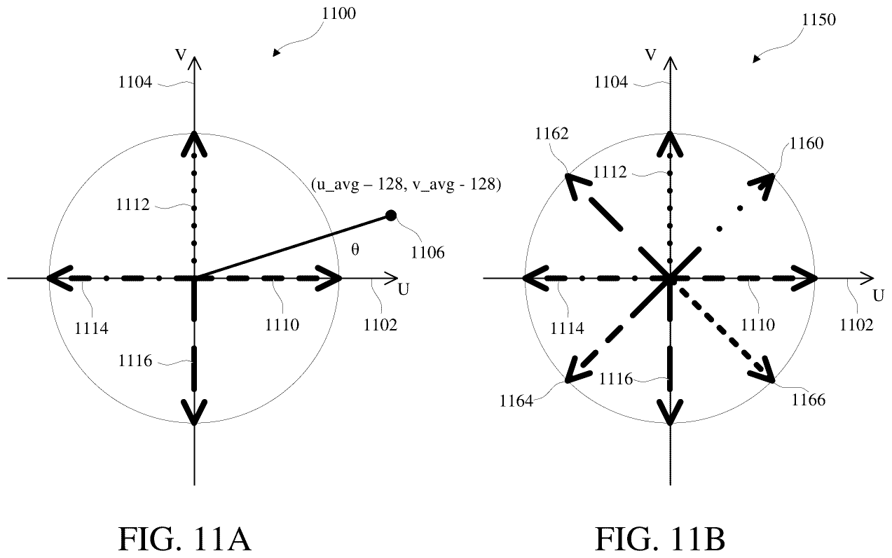

The technique 700 includes determining 706 a color for focus peaking highlighting based on the second component image and on the third component image. The color may be determined 706 based on all the pixels of the second component image and the third component image, or based a smaller subset of the pixels of the second component image and the third component image. For example, color may be determined 706 based on analysis of only the selected 704 pixels of the color image. In some implementations, the color for focus peaking highlighting is selected from among a discrete set of available colors (e.g., red, green, blue, or yellow) as illustrated in FIGS. 11A and 11B. The color may be determined 706 to enhance visibility of the focus peaking highlighting in the context of the colors of the scene shown in the color image. For example, determining 706 the color for focus peaking highlighting may include implementing the technique 1000 of FIG. 10.

The technique 700 includes applying 708 focus peaking highlighting, of the color for focus peaking highlighting, to the selected pixels of the color image to obtain a highlighted image. In some implementations, the focus peaking highlighting is applied 708 by setting selected pixels of the second component image and the third component image to values corresponding to the color for focus peaking highlighting. In some implementations, the focus peaking highlighting is applied 708 by adding offsets corresponding to the color for focus peaking highlighting to selected pixels of the second component image and the third component image. For example, the magnitude of a vector offset added to a selected pixel pair of the second component image and the third component image may be proportional to the value of the focus peaking signal corresponding to this pair of pixel values and at an angle in the color plane corresponding to the selected color for focus peaking highlighting in the color image. The focus peaking highlighting may provide an easy to perceive indication of which portions of the color image are in focus. An image based on the highlighted image (e.g., the highlighted image itself or a result of additional image processing and/or compression operations) may be transmitted, stored, and/or displayed. For example, the highlighted image or a lower resolution copy of the highlighted image may be displayed via a display interface of an image capture apparatus (e.g., via the display 142, the display 224, or the display 566), which may help a user to focus a camera on an object of interest in a scene depicted in the color image.

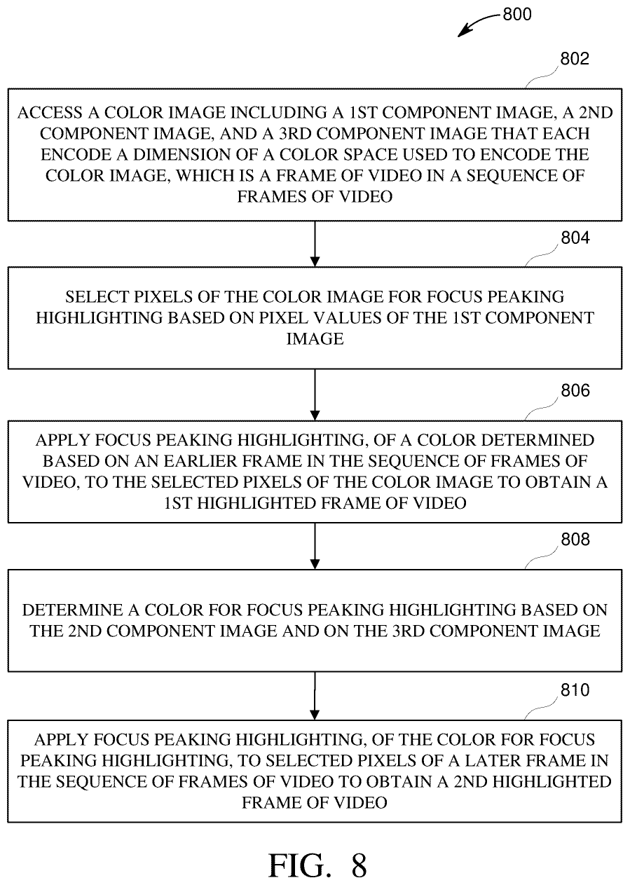

FIG. 8 is a flowchart of an example of a technique 800 for applying focus peaking highlighting to frames of video with a delay in the adjustment of color for focus peaking highlighting. For example, real-time processing constraints of video capture may make it advantageous to introduce a delay of one or more frames of video between analysis of a frame of video to select a color suiting a scene and the application of this dynamically selected color for focus peaking highlighting. The technique 800 includes accessing 802 a color image including a first component image, a second component image, and a third component image that each encode a dimension of a color space used to encode the color image, where the color image is a frame video in a sequence of frames of video; selecting 804 pixels of the color image for focus peaking highlighting based on pixel values of the first component image; applying 806 focus peaking highlighting, of a color determined based on an earlier frame in sequence of frames of video, to the selected pixels of the color image to obtain a first highlighted frame of video; determining 808 a color for focus peaking highlighting based on the second component image and on the third component image; and applying 810 focus peaking highlighting, of the color for focus peaking highlighting, to selected pixels of a later frame in the sequence of frames of video to obtain a second highlighted frame of video.

For example, the technique 800 may be implemented using the image capture apparatus 100 of FIGS. 1A-B. For example, the technique 800 may be implemented using the image capture apparatus 200 of FIGS. 2A-B. For example, the technique 800 may be implemented using the image capture apparatus 300 of FIG. 3. For example, the technique 800 may be implemented using the image capture apparatus 400 of FIG. 4. For example, the technique 800 may be implemented using an image sensor (e.g., the image sensor 512) and a processing apparatus (e.g., including the processing components 520 of the image capture apparatus 500 of FIG. 5). Software for implementing the technique 800 may be stored on a non-transitory computer-readable storage medium storing executable instructions that, when executed by a processor, cause performance of operations used to implement the technique 800.

The technique 800 includes accessing 802 a color image including a first component image, a second component image, and a third component image that each encode a dimension of a color space used to encode the color image. The color image may be a frame of video. The color image may be encoded in many different formats, using various color space representations (e.g., YUV, RGB, HSV (hue, saturation, value), or the L*a*b* color space). In some implementations, the first component image encodes luminance pixel values, the second component image encodes a first chrominance channel of the color image, and the third component image encodes a second chrominance channel of the color image. The color image may have been converted between different color spaces between when it is captured using an image sensor (e.g., the image sensor 512) and when it is accessed 802. For example, the color image may be captured in an RGB format, converted to a YCbCr format and then accessed 802 as a YCbCr color image. The different component images of the color image may be encoded with different resolutions. For example, the color image may be encoded as a YUV 4:2:0 semi-planar 8-bit picture, where for every four luminance pixels corresponds to one pixel from each of the two chrominance channels (U, V). For example, the color image may be accessed 802 from an image sensor (e.g., the image sensor 512) via a bus (e.g., the bus 580). In some implementations, the color image may be accessed 802 via a communications link. For example, the color image may be accessed 802 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the color image may be accessed 802 via the data interface components 530. For example, the color image may be accessed 802 via an ISP (e.g., the ISP 620) that performs some initial processing on the accessed 802 color image. For example, the color image may be stored in a format using the Bayer color mosaic pattern.

The technique 800 includes selecting 804 pixels of the color image for focus peaking highlighting based on pixel values of the first component image. In some implementations, pixels may be selected 804 for focus peaking highlighting based on application of a 2-D edge filter (e.g., a Sobel filter) to the first component image (e.g., a luminance channel component image). For example, the technique 900 of FIG. 9 may be used to select 804 pixels of the color image for focus peaking highlighting based on pixel values of the first component image.

The technique 800 includes applying 806 focus peaking highlighting, of a color determined based on an earlier frame in the sequence of frames of video, to the selected pixels of the color image to obtain a first highlighted frame of video. In some implementations, the focus peaking highlighting is applied 806 by setting selected pixels of the second component image and the third component image to values corresponding to the color for focus peaking highlighting. In some implementations, the focus peaking highlighting is applied 806 by adding offsets corresponding to the color for focus peaking highlighting to selected pixels of the second component image and the third component image. For example, the magnitude of a vector offset added to a selected pixel pair of the second component image and the third component image may be proportional to the value of the focus peaking signal corresponding to this pair of pixel values and at an angle in the color plane corresponding to the selected color for focus peaking highlighting in the first highlighted frame of video. The focus peaking highlighting may provide an easy to perceive indication of which portions of the color image are in focus. An image based on the first highlighted frame of video (e.g., the first highlighted frame of video itself or a result of additional image processing and/or compression operations) may be transmitted, stored, and/or displayed. For example, the first highlighted frame of video or a lower resolution copy of the first highlighted frame of video may be displayed via a display interface of an image capture apparatus (e.g., via the display 142, the display 224, or the display 566), which may help a user to focus a camera on an object of interest in a scene depicted in the sequence of frames of video.

The technique 800 includes determining 808 a color for focus peaking highlighting based on the second component image and on the third component image. The color may be determined 808 based on all the pixels of the second component image and the third component image, or based a smaller subset of the pixels of the second component image and the third component image. For example, color may be determined 808 based on analysis of only the selected 804 pixels of the color image/current frame of video. In some implementations, the color for focus peaking highlighting is selected from among a discrete set of available colors (e.g., red, green, blue, magenta, light blue, light green, orange or yellow) as illustrated in FIGS. 11A and 11B. The color may be determined 808 to enhance visibility of the focus peaking highlighting in the context of the colors of the scene shown in the color image/current frame of video. For example, determining 808 the color for focus peaking highlighting may include implementing the technique 1000 of FIG. 10.

The technique 800 includes applying 810 focus peaking highlighting, of the color for focus peaking highlighting, to selected pixels of a later frame in the sequence of frames of video to obtain a second highlighted frame of video. In some implementations, the focus peaking highlighting is applied 810 by setting selected pixels of the later frame in the sequence of frames of video to values corresponding to the color for focus peaking highlighting. In some implementations, the focus peaking highlighting is applied 810 by adding offsets corresponding to the color for focus peaking highlighting to selected pixels of the chrominance channel components of the later frame in the sequence of frames of video. For example, the magnitude of a vector offset added to a selected pixel pair of the second component image and the third component image may be proportional to the value of the focus peaking signal corresponding to this pair of pixel values and at an angle in the color plane corresponding to the selected color for focus peaking highlighting in the second highlighted frame of video.

The focus peaking highlighting may provide an easy to perceive indication of which portions of the later frame of video are in focus. An image based on the second highlighted frame of video (e.g., the second highlighted frame of video itself or a result of additional image processing and/or compression operations) may be transmitted, stored, and/or displayed. For example, the second highlighted frame of video or a lower resolution copy of the second highlighted frame of video may be displayed via a display interface of an image capture apparatus (e.g., via the display 142, the display 224, or the display 566), which may help a user to focus a camera on an object of interest in a scene depicted in the sequence of frames of video. In some implementations, the technique 800 may include presenting a video including the first highlighted frame of video and the second highlighted frame of video using a display (e.g., the display 142, the display 224, or the display 566).

FIG. 9 is a flowchart of an example of a technique 900 for selecting pixels of a color image for focus peaking highlighting. The technique 900 includes determining 902 an edge filter response for pixels of the first component image; determining 904 an edge signal as an absolute value of the edge filter response for pixels of the first component image; determining 906 a focus peaking signal as a maximum value of the edge signal over a neighborhood of pixels of the first component image that is centered around a pixel of the second component image and the third component image; if (at step 907) the focus peaking signal is not above a threshold, then the technique 900 finishes 908 with no change to the pixel of the second component image and the third component image; and, if (at step 907) the focus peaking signal is above the threshold, then the technique 900 includes modifying 910 the pixel of the second component image and the third component image for focus peaking highlighting based on the color for focus peaking highlighting.

Steps 906 through 910 may be repeated for each corresponding pair of pixels from the second component image and the third component image in order to select pixels of a color image for focus peaking highlighting. For example, the technique 900 may be implemented using the image capture apparatus 100 of FIGS. 1A-B. For example, the technique 900 may be implemented using the image capture apparatus 200 of FIGS. 2A-B. For example, the technique 900 may be implemented using the image capture apparatus 300 of FIG. 3. For example, the technique 900 may be implemented using the image capture apparatus 400 of FIG. 4. For example, the technique 900 may be implemented using an image sensor (e.g., the image sensor 512) and a processing apparatus (e.g., including the processing components 520 of the image capture apparatus 500 of FIG. 5). Software for implementing the technique 900 may be stored on a non-transitory computer-readable storage medium storing executable instructions that, when executed by a processor, cause performance of operations used to implement the technique 900.

FIG. 10 is a flowchart of an example of a technique 1000 for determining a color for focus peaking highlighting. The technique 1000 includes determining 1002 a first average for pixel values of the second component image; determining 1004 a second average for pixel values of the third component image; determining 1006 an angle based on the first average and the second average; and determining 1008 the color for focus peaking highlighting based on the angle. For example, the technique 1000 may be implemented using the image capture apparatus 100 of FIGS. 1A-B. For example, the technique 1000 may be implemented using the image capture apparatus 200 of FIGS. 2A-B. For example, the technique 1000 may be implemented using the image capture apparatus 300 of FIG. 3. For example, the technique 1000 may be implemented using the image capture apparatus 400 of FIG. 4. For example, the technique 1000 may be implemented using an image sensor (e.g., the image sensor 512) and a processing apparatus (e.g., including the processing components 520 of the image capture apparatus 500 of FIG. 5). Software for implementing the technique 1000 may be stored on a non-transitory computer-readable storage medium storing executable instructions that, when executed by a processor, cause performance of operations used to implement the technique 1000.

The technique 1000 includes determining 1002 a first average for pixel values of the second component image. The first average may be calculated for all of the pixels of the second component image or for a smaller subset (e.g., the selected pixels) of the pixels of the second component image. The technique 1000 includes determining 1004 a second average for pixel values of the third component image. The second average may be calculated for all of the pixels of the third component image or for a smaller subset (e.g., the selected pixels) of the pixels of the third component image. In some implementations, only the selected pixels of the color image are used to compute the first average and the second average.

The technique 1000 includes determining 1006 an angle based on the first average and the second average. In some implementations, the angle is determined 1006 using an arctangent function (e.g., implemented using a look-up table or a Taylor series approximation) with a ratio based on the first average and the second average as an input argument. For example, the angle may be determined as arctangent( (V_avg-128)/(U_avg-128)), where U_avg is the first average, V_avg is the second average, the second component image is encoded with 8-bit unsigned pixel values, and the third component image is encoded with 8-bit unsigned pixel values. The angle is equivalent to a unit vector in the plane of the color space with dimensions corresponding to the second component image and the third component image in that they are equivalent ways of encoding or expressing a direction from the origin in the plane. Thus, for example, the angle may be expressed or encoded as a unit vector, or in degrees, or in radians.

The technique 1000 includes determining 1008 the color for focus peaking highlighting based on the angle. The color for focus peaking highlighting may be determined 1008 to provide good visual contrast with the average color represented by the angle. In some implementations, the color for focus peaking highlighting is determined 1008 to be rotated 180 degrees from the angle in a plane of the color space with dimensions corresponding to the second component image and the third component image. In some implementations, the color for focus peaking highlighting is determined 1008 to be rotated 90 degrees (e.g., clockwise or counterclockwise) from the angle in a plane of the color space with dimensions corresponding to the second component image and the third component image. In some implementations, the angle is quantized to a nearest angle from a discrete set of supported angles in a plane of the color space with dimensions corresponding to the second component image and the third component image and each supported angle is mapped to a color for focus peaking highlighting that contrasts well with the colors corresponding to the angle. For example, the angle may be quantized to the nearest of four angles (e.g., 0°, 90°, 180°, or 270°) as illustrated in FIG. 11A, or quantized to the nearest of eight angles (e.g., 0°, 45°, 90°, 135°, 180°, 225°, 270°, or 315°) as illustrated in FIG. 11B.

FIGS. 11A-B are illustrations of examples of a normalized color representation for a scene and a corresponding color for focus peaking highlighting in a plane of color components. FIG. 11A is a plot 1100 of a plane of color components that illustrates a set of four discrete colors (1110, 1112, 1114, and 1116) that may be selected for focus peaking highlighting in a color image based on statistics of color components in a scene. The plane has a U axis 1102 corresponding to a second component image encoding a chrominance color channel in a particular color space representation (e.g., a YUV color space) of the color image. The plane has a V axis 1104 corresponding to a third component image encoding another chrominance color channel in the particular color space representation of the color image. The four candidate colors (1110, 1112, 1114, and 1116) for focus peaking highlighting are each illustrated as a unit vector in the plane with different dash patterns representing different colors corresponding to their respective angles in the plane of color components. For example, the candidate color 1110 may be blue, the candidate color 1112 may be red, the candidate color 1114 may be yellow, and the candidate color 1116 may be green. The plot 1100 shows a point 1106 in the plane of color components determined based on average statistics for pixels of the second component image and the third component image, which may be representative of the dominant colors appearing in a scene. For example, the point 1106 may have the coordinates (u_avg-128, v_avg-128), where u_avg is an average of pixel values in a second component image encoding a U color channel, v_avg is an average of pixel values in a third component image encoding a V color channel, the second component image is encoded with 8-bit unsigned pixel values, and the third component image is encoded with 8-bit unsigned pixel values. The plot 1100 also shows an angle, θ, that the vector from the origin in the plane to the point 1106 makes with the U axis 1102, which may correspond to a dominant color in a scene depicted in the color image.

To determine the main or dominant color of a scene, statistics on the chrominance color channel pixels (e.g., U and V samples) in a picture of the scene may be collected. In this example, to determine the main or dominant color of a picture, statistics on the U and V samples in the picture are collected. All of the U samples are averaged to get u_avg. All of the V samples are averaged to get v_avg. Then, the 2D vector (u_avg-128, v_avg-128) and angle θ it makes with the horizontal axis are computed. The angle θ may be compared to predefined angles, which are related to specific colors in the YUV color space. For example, blue at 0°, yellow at 180°, red at 90° and green at −90°. This analysis may provide an indication of the dominant color in the image. An opposite color to the dominant color may be picked for the focus peaking highlighting. For example, yellow may be selected if the dominant color is blue, blue may be selected if the dominant color is yellow, or red may be selected if the dominant color is green.

For the example illustrated in plot 1100, the angle, θ, for the point 1106 is closest to the candidate color 1110 (blue), so the candidate color 1114 (yellow) may be selected as the color for focus peaking highlighting.

More candidate colors may be considered to better contrast with the dominant color of the scene by considering angles at every 45°. FIG. 11B is a plot 1150 of the plane of color components that illustrates a larger set of eight discrete colors (1110, 1112, 1114, 1116, 1160, 1162, 1164, and 1166) that may be selected for focus peaking highlighting in a color image based on statistics of color components in a scene. In addition to the four candidate colors illustrated in FIG. 11A, the plot 1150 shows four more candidate colors (1160, 1162, 1164, and 1166) represented by unit vectors with different dash patterns. For example, the candidate color 1160 may be magenta, the candidate color 1162 may be orange, the candidate color 1164 may be light green, and the candidate color 1166 may be light blue. In some implementations, a candidate color that is closest to the opposite (i.e., 180° rotation) from the angle, θ, of the dominant color of the scene is selected. For example, for dominant color magenta (˜45°), the opposite color light green may be selected. For example, for dominant color light blue (˜−45°), the opposite color orange may be selected. For example, for dominant color orange (˜135°), the opposite color light blue may be selected. For example, for dominant color light green (˜−135°), the opposite color magenta may be selected.

The methods and techniques of automated color selection for focus peaking highlighting described herein, or aspects thereof, may be implemented by an image capture apparatus, or one or more components thereof, such as the image capture apparatus 100 shown in FIG. 1A-1B, the image capture apparatus 200 shown in FIG. 2A-2B, the image capture apparatus 300 shown in FIG. 3, the image capture apparatus 400 shown in FIG. 4A-4B, or the image capture apparatus 500 shown in FIG. 5. The methods and techniques of automated color selection for focus peaking highlighting described herein, or aspects thereof, may be implemented by an image capture device, such as the image capture device 104 shown in FIG. 1A-1B, one or more of the image capture devices 204, 206 shown in FIG. 2A-2B, one or more of the image capture devices 304, 306 shown in FIG. 3, the image capture device 404 shown in FIG. 4A-4B, or an image capture device of the image capture apparatus 500 shown in FIG. 5. The methods and techniques of automated color selection for focus peaking highlighting described herein, or aspects thereof, may be implemented by an image processing pipeline, or one or more components thereof, such as the image processing pipeline 600 shown in FIG. 6.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
accessing a color image including a first component image, a second component image, and a third component image that each encode a dimension of a color space used to encode the color image;
selecting pixels of the color image for focus peaking highlighting based on pixel values of the first component image; and
determining a color for focus peaking highlighting based on the second component image and on the third component image.

2. The method of claim 1, wherein determining the color for focus peaking highlighting comprises:
determining a first average for pixel values of the second component image;
determining a second average for pixel values of the third component image;
determining an angle based on the first average and the second average; and
determining the color for focus peaking highlighting based on the angle.

3. The method of claim 2, wherein the color for focus peaking highlighting is determined to be rotated 180 degrees from the angle in a plane of the color space with dimensions corresponding to the second component image and the third component image.

4. The method of claim 2, wherein the color for focus peaking highlighting is determined to be rotated 90 degrees from the angle in a plane of the color space with dimensions corresponding to the second component image and the third component image.

5. The method of claim 2, wherein the angle is quantized to a nearest angle from a discrete set of supported angles in a plane of the color space with dimensions corresponding to the second component image and the third component image and each supported angle is mapped to a color for focus peaking highlighting that contrasts well with the colors corresponding to the angle.

6. The method of claim 2, wherein only the selected pixels of the color image are used to compute the first average and the second average.

7. The method of claim 1, further comprising:
applying focus peaking highlighting, of the color for focus peaking highlighting, to the selected pixels of the color image to obtain a highlighted image.

8. The method of claim 1, wherein the color image is a frame video in a sequence of frames of video, and further comprising:
applying focus peaking highlighting, of a color determined based on an earlier frame in the sequence of frames of video, to the selected pixels of the color image to obtain a first highlighted frame of video; and
applying focus peaking highlighting, of the color for focus peaking highlighting, to selected pixels of a later frame in the sequence of frames of video to obtain a second highlighted frame of video.

9. The method of claim 1, wherein the first component image encodes luminance pixel values, the second component image encodes a first chrominance channel of the color image, and the third component image encodes a second chrominance channel of the color image.

10. A system, comprising:
an image sensor, and
a processing apparatus configured to:
access a color image, captured using the image sensor, including a first component image, a second component image, and a third component image that each encode a dimension of a color space used to encode the color image;
select pixels of the color image for focus peaking highlighting based on pixel values of the first component image; and
determine a color for focus peaking highlighting based on the second component image and on the third component image.

11. The system of claim 10, wherein the processing apparatus is configured to:
determine a first average for pixel values of the second component image;
determine a second average for pixel values of the third component image;
determine an angle based on the first average and the second average; and
determine the color for focus peaking highlighting based on the angle.

12. The system of claim 11, wherein the color for focus peaking highlighting is determined to be rotated 180 degrees from the angle in a plane of the color space with dimensions corresponding to the second component image and the third component image.

13. The system of claim 11, wherein the color for focus peaking highlighting is determined to be rotated 90 degrees from the angle in a plane of the color space with dimensions corresponding to the second component image and the third component image.

14. The system of claim 11, wherein the angle is quantized to a nearest angle from a discrete set of supported angles in a plane of the color space with dimensions corresponding to the second component image and the third component image and each supported angle is mapped to a color for focus peaking highlighting that contrasts well with the colors corresponding to the angle.

15. The system of claim 11, wherein only the selected pixels of the color image are used to compute the first average and the second average.

16. The system of claim 10, further comprising a display, and wherein the processing apparatus is configured to:
apply focus peaking highlighting, of the color for focus peaking highlighting, to the selected pixels of the color image to obtain a highlighted image; and
present the highlighted image using the display.

17. The system of claim 10, further comprising a display, and wherein the color image is a frame video in a sequence of frames of video, and wherein the processing apparatus is configured to:
apply focus peaking highlighting, of a color determined based on an earlier frame in the sequence of frames of video, to the selected pixels of the color image to obtain a first highlighted frame of video;
apply focus peaking highlighting, of the color for focus peaking highlighting, to selected pixels of a later frame in sequence of frames of video to obtain a second highlighted frame of video; and
present a video including the first highlighted frame of video and the second highlighted frame of video using the display.

18. The system of claim 10, wherein the first component image encodes luminance pixel values, the second component image encodes a first chrominance channel of the color image, and the third component image encodes a second chrominance channel of the color image.

19. A non-transitory computer-readable storage medium storing executable instructions that, when executed by a processor, cause performance of operations, comprising operations to:
access a color image including a first component image, a second component image, and a third component image that each encode a dimension of a color space used to encode the color image;
select pixels of the color image for focus peaking highlighting based on pixel values of the first component image; and
determine a color for focus peaking highlighting based on the second component image and on the third component image.

20. The non-transitory computer-readable storage medium of claim 19, wherein determining the color for focus peaking highlighting comprises operations to:
determine a first average for pixel values of the second component image;
determine a second average for pixel values of the third component image;
determine an angle based on the first average and the second average; and
determine the color for focus peaking highlighting based on the angle.
